(19) United States
(12) Patent Application Publication
(10) Pub. No.: US 2021/0135244 A1
(43) Pub. Date: May 6, 2021

(54) ELECTROLYTE MEMBRANE FOR MEMBRANE-ELECTRODE ASSEMBLIES CONTAINING CATALYST HAVING POLYHEDRAL FRAMEWORK AND METHOD OF MANUFACTURING THE SAME

(71) Applicants: HYUNDAI MOTOR COMPANY, SEOUL (KR); KIA MOTORS CORPORATION, SEOUL (KR)

(72) Inventor: Ju Ahn Park, Yongin-si (KR)

(21) Appl. No.: 17/070,636

(22) Filed: Oct. 14, 2020

(30) Foreign Application Priority Data
Oct. 31, 2019 (KR) 10-2019-0137464

(51) Int. Cl. H01M 4/88; H01M 4/92; H01M 4/86; H01M 8/1004

(52) U.S. Cl. CPC H01M 4/8892; H01M 4/921; H01M 8/1004; H01M 4/8652; H01M 4/8657

(57) ABSTRACT

The present disclosure relates to an electrolyte membrane for membrane-electrode assemblies containing a catalyst including a hollow nanoparticle having a polyhedral framework and a method of manufacturing the same. Specifically, the electrolyte membrane includes an electrolyte layer including a proton conductive ionomer and a catalyst dispersed in the electrolyte layer, wherein the catalyst includes a hollow nanoparticle having a polyhedral framework.

### CROSS REFERENCE TO RELATED APPLICATIONS

This application claims, under 35 U.S.C. § 119(a), the benefit of priority to Korean Patent Application No. 10-2019-0137464 filed on Oct. 31, 2019, the entire contents of which are incorporated herein by reference.

### BACKGROUND

### (a) Technical Field

The present disclosure relates to an electrolyte membrane for membrane-electrode assemblies containing a catalyst including a hollow nanoparticle having a polyhedral framework and a method of manufacturing the same.

### (b) Background Art

In a polymer electrolyte membrane fuel cell (PEMFC), an electrolyte membrane serves to conduct hydrogen ions. The electrolyte membrane is manufactured using an ion exchange material in order to transfer hydrogen ions. The ion exchange material contains moisture in order to selectively move hydrogen ions, generated at a negative electrode, to a positive electrode.

Durability of the electrolyte membrane is reduced by degradation of the electrolyte membrane due to the crossover of hydrogen. Due to the crossover of hydrogen, the hydrogen contacts oxygen at the interface between the electrolyte membrane and the positive electrode, whereby hydrogen peroxide is generated. The hydrogen peroxide is dissolved into a hydroxyl radical (.OH) and a hydroperoxyl radical (.OOH), and the electrolyte membrane is degraded.

In recent years, the thickness of the electrolyte membrane has been reduced in order to reduce cost and to reduce ion resistance of the electrolyte membrane. The thinner the electrolyte membrane, the greater the crossover amount of hydrogen. As a result, the lifespan of the electrolyte membrane gradually decreases.

In order to solve the above problem, technology for adding a catalyst, such as carbon-supported platinum, to the electrolyte membrane in order to prevent generation of radicals has been proposed.

However, in the case in which the catalyst is added to the electrolyte membrane, as described above, insulation of the electrolyte membrane may be broken by the carbon support, and the electrolyte membrane may be damaged due to degradation and/or side reaction of the carbon support.

The above information disclosed in this Background section is provided only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art.

It is an object of the present disclosure to add a catalyst that has no carbon support, has a polyhedral framework, and thus is self-supported to an electrolyte membrane, thereby improving chemical durability of the electrolyte membrane without side effects due to the carbon support.

The objects of the present disclosure are not limited to those described above. The objects of the present disclosure will be clearly understood from the following description and could be implemented by means defined in the claims and a combination thereof.

In one aspect, the present disclosure provides an electrolyte membrane for membrane-electrode assemblies, the electrolyte membrane including an electrolyte layer including a proton conductive ionomer and a catalyst dispersed in the electrolyte layer, wherein the catalyst includes a hollow nanoparticle having a polyhedral framework.

The ionomer may include a perfluorinated ionomer.

The framework of the catalyst may include catalyst metal selected from a group consisting of platinum (Pt), palladium (Pd), rhodium (Rh), iridium (Ir), ruthenium (Ru), and a combination thereof.

The catalyst may be self-supported.

The catalyst may have an average particle diameter of 40 nm to 70 nm.

The content of the catalyst may be 0.001 mg/cm³ to 0.2 mg/cm³.

The electrolyte membrane may further include a porous reinforcement layer impregnated with an ionomer, wherein the electrolyte layer may be formed on at least one surface of the reinforcement layer.

The reinforcement layer may include any one selected from the group consisting of polytetrafluoroethylene (PTFE), expanded polytetrafluoroethylene (e-PTFE), polyethylene (PE), polypropylene (PP), polyphenylene oxide (PPO), polybenzimidazole (PBI), polyimide (PI), polyvinylidene fluoride (PVdF), polyvinyl chloride (PVC), and a combination thereof.

In another aspect, the present disclosure provides a method of manufacturing an electrolyte membrane for membrane-electrode assemblies, the method including preparing a catalyst including a hollow nanoparticle having a polyhedral framework, manufacturing a mixture including the catalyst and a proton conductive ionomer, and forming an electrolyte layer using the mixture.

The preparing of a catalyst may include preparing a polyhedral template particle, growing catalyst metal along edges of the template particle to form a polyhedral framework, and removing the template particle.

The forming of a polyhedral framework may include depositing a very small amount of metal to be replaced on a surface of the template particle, and replacing the metal to be replaced by catalyst metal and site-selectively growing the catalyst metal along the edges of the template particle.

The template particle may include any one selected from the group consisting of gold (Au), copper (Cu), cobalt (Co), and a combination thereof.

The metal to be replaced may include any one selected from the group consisting of silver (Ag), copper (Cu), nickel (Ni), and a combination thereof.

The catalyst metal may include any one selected from the group consisting of platinum (Pt), palladium (Pd), rhodium (Rh), iridium (Ir), ruthenium (Ru), and a combination thereof.

The template particle may be removed in a solution by etching using an etchant.

The catalyst may have an average particle diameter of 40 nm to 70 nm.

The mixture may be manufactured by mixing the catalyst with the ionomer in the presence of an alcohol-based solvent.

The content of the catalyst may be 0.001 mg/cm³ to 0.2 mg/cm³.

A porous reinforcement layer may be impregnated with an ionomer, and the mixture may be coated on at least one surface of the reinforcement layer impregnated with the ionomer to form an electrolyte layer.

The reinforcement layer may include any one selected from the group consisting of polytetrafluoroethylene (PTFE), expanded polytetrafluoroethylene (e-PTFE), polyethylene (PE), polypropylene (PP), polyphenylene oxide (PPO), polybenzimidazole (PBI), polyimide (PI), polyvinylidenefluoride (PVdF), polyvinyl chloride (PVC), and a combination thereof.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a sectional view schematically showing a membrane-electrode assembly (MEA) according to the present disclosure;

FIG. 2 is a sectional view schematically showing an embodiment of an electrolyte membrane according to the present disclosure;

FIG. 3 is a view schematically showing a catalyst according to the present disclosure;

FIG. 4 is a sectional view schematically showing another embodiment of the electrolyte membrane according to the present disclosure;

FIG. 5 is a flowchart schematically showing a method of manufacturing an electrolyte membrane according to the present disclosure;

FIGS. 6A, 6B, and 6C are reference views illustrating a step of preparing a catalyst;

FIG. 7A is a view showing the result of analysis of a catalyst according to Manufacturing Example using a transmission electron microscope;

FIG. 7B is a view showing the result of analysis of the catalyst according to Manufacturing Example using an energy dispersive X-ray spectroscope (EDS); and

FIG. 8 is a view showing the result of evaluation of durability of the membrane-electrode assembly according to the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The objects described above, and other objects, features and advantages will be clearly understood from the following preferred embodiments with reference to the attached drawings. However, the present disclosure is not limited to the embodiments and will be embodied in different forms. The embodiments are suggested only to offer thorough and complete understanding of the disclosed contents and sufficiently inform those skilled in the art of the technical concept of the present disclosure.

It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof. In addition, it will be understood that, when an element such as a layer, film, region or substrate is referred to as being “on” another element, it can be directly on the other element or an intervening element may also be present. It will also be understood that, when an element such as a layer, film, region or substrate is referred to as being “under” another element, it can be directly under the other element or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures among other things. For this reason, it should be understood that, in all cases, the term “about” should modify all numbers, figures and/or expressions. In addition, when numeric ranges are disclosed in the description, these ranges are continuous and include all numbers from the minimum to the maximum including the maximum within the range unless otherwise defined. Furthermore, when the range refers to an integer, it includes all integers from the minimum to the maximum including the maximum within the range, unless otherwise defined.

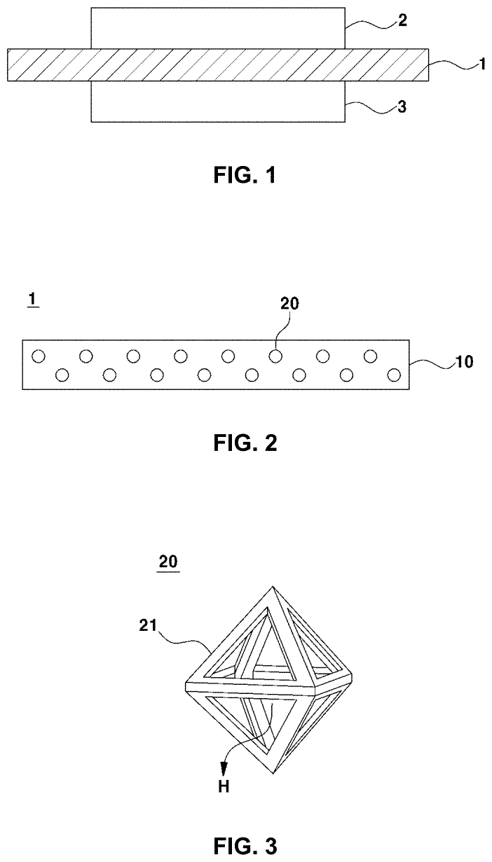

FIG. 1 is a sectional view schematically showing a membrane-electrode assembly (MEA) according to the present disclosure. Referring to this figure, the membrane-electrode assembly includes an electrolyte membrane 1, a positive electrode 2 formed on one surface of the electrolyte membrane 1, and a negative electrode 3 formed on the other surface of the electrolyte membrane 1.

The positive electrode 2 reacts with oxygen in air, and the negative electrode 3 reacts with hydrogen. Specifically, the negative electrode 3 decomposes hydrogen into protons and electrons through hydrogen oxidation reaction (HOR). The protons move to the positive electrode 2 through the electrolyte membrane 1, which contacts the negative electrode 3. The electrons move to the positive electrode 2 through an external wire (not shown).

Each of the positive electrode 2 and the negative electrode 3 may include a catalyst, such as carbon-supported platinum (Pt/C). In addition, a proton conductive polymer may be included in order to conduct protons therein.

FIG. 2 is a sectional view schematically showing an embodiment of an electrolyte membrane 1 according to the present disclosure. Referring to this figure, the electrolyte membrane 1 may include an electrolyte layer 10 and a catalyst 20 dispersed in the electrolyte layer 10.

The electrolyte layer 10 physically separates the positive electrode 2 and the negative electrode 3 from each other, and allows protons to move between the positive electrode 2 and the negative electrode 3 therethrough. Consequently, the electrolyte layer 10 may include a proton conductive ionomer.

The ionomer is not particularly restricted as long as the ionomer is a proton conductive polymer. For example, the ionomer may be a perfluorinated ionomer. The perfluorinated ionomer may be perfluorosulfonic acid, perfluorocarboxylic acid, a copolymer of tetrafluoroethylene and fluoro vinyl ether including a sulfonic acid group, a combination thereof, commercial Nafion, Flemion, Aciplex, 3M ionomer, Dow ionomer, Solvay ionomer, Sumitomo 3M ionomer, or a mixture thereof.

The catalyst 20 is dispersed in the electrolyte membrane 10 in order to remove hydrogen and oxygen crossing over in the electrolyte membrane 10.

FIG. 3 is a view schematically showing the catalyst 20. Referring to this figure, the catalyst 20 has a polyhedral framework 21 defined by frames interconnected three-dimensionally, and may be a hollow (H) nanoparticle.

The framework 21 may include catalyst metal selected from the group consisting of platinum (Pt), palladium (Pd), rhodium (Rh), iridium (Ir), ruthenium (Ru), and a combination thereof.

Since the catalyst 20 is configured to have a polyhedral framework 21 defined by frames that are interconnected, the catalyst 20 is self-supported. That is, the catalyst 20 includes no separate support. Consequently, the electrolyte membrane 1 to which the catalyst 20 is applied does not suffer from side effects due to the support. In addition, the catalyst 20 is hollow (H), whereby specific surface area of the catalyst 20 is increased and thus catalyst activity is also greatly improved.

The catalyst 20 may have an average particle diameter of 40 nm to 70 nm. The average particle diameter may be measured using a commercial laser diffraction and scattering type particle size distribution measuring instrument, such as a micro track particle size distribution measuring instrument. In addition, 200 particles may be extracted from an electron micrograph in order to calculate the average particle diameter.

The content of the catalyst 20 may be 0.001 mg/cm³ to 0.2 mg/cm³. If the content of the catalyst 20 is less than the above range, the effect of adding the catalyst 20 may be insignificant. If the content of the catalyst 20 is greater than the above range, an increase in cost may be caused.

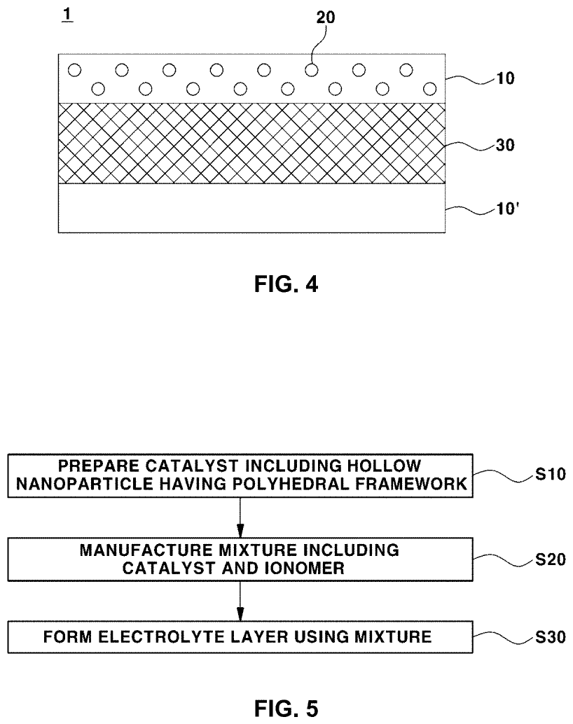

FIG. 4 is a sectional view schematically showing another embodiment of the electrolyte membrane 1 according to the present disclosure. Referring to this figure, the electrolyte membrane 1 may include a reinforcement layer 30 and an electrolyte layer 10 formed on at least one surface of the reinforcement layer 30.

The reinforcement layer 30 increases mechanical rigidity of the electrolyte membrane 1.

The reinforcement layer 30 may be selected from the group consisting of polytetrafluoroethylene (PTFE), expanded polytetrafluoroethylene (e-PTFE), polyethylene (PE), polypropylene (PP), polyphenylene oxide (PPO), polybenzimidazole (PBI), polyimide (PI), polyvinylidene fluoride (PVdF), polyvinyl chloride (PVC), and a combination thereof.

The reinforcement layer 30 may be a porous membrane, and may be impregnated with a proton conductive ionomer. Here, the ionomer with which the reinforcement layer 30 is impregnated may be identical to or different from the ionomer included in the electrolyte layer 10.

An electrolyte layer 10 in which a catalyst 20 is dispersed, as described above, may be formed on one surface or opposite surfaces of the reinforcement layer 30. In addition, as shown in FIG. 4, an electrolyte layer 10 in which a catalyst 20 is dispersed may be formed on one surface of the reinforcement layer 30, and an electrolyte layer 10′ in which no catalyst 20 is dispersed may be formed on the other surface of the reinforcement layer 30.

FIG. 5 is a flowchart schematically showing a method of manufacturing an electrolyte membrane according to the present disclosure. Referring to this figure, the method includes a step of preparing a catalyst including a hollow nanoparticle having a polyhedral framework at S10, a step of manufacturing a mixture including the catalyst and an ionomer at S20, and a step of forming an electrolyte layer using the mixture at S30.

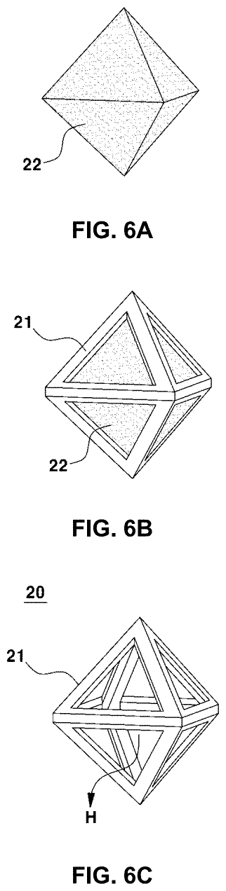

FIGS. 6A to 6C are reference views illustrating the step of preparing a catalyst.

The step of preparing a catalyst at S10 may include a step of preparing a polyhedral template particle 22, as shown in FIG. 6A, a step of growing catalyst metal along edges of the template particle 22 to form a polyhedral framework 21, as shown in FIG. 6B, a step of removing the template particle 22 to obtain a catalyst, as shown in FIG. 6C.

In FIG. 6A, the template particle 22 is shown as an octahedron. However, the shape of the template particle 22 is not limited thereto. The template particle 22 may have any polyhedral shape as long as the polyhedral shape includes edges at which surfaces abut each other.

The template particle 22 may include any one selected from the group consisting of gold (Au), copper (Cu), cobalt (Co), and a combination thereof.

At the step of forming a polyhedral framework 21, as shown in FIG. 6B, a very small amount of metal to be replaced (not shown) may be deposited on the surface of the template particle 22, the metal to be replaced may be replaced by catalyst metal, and the catalyst metal may be site-selectively grown along the edges of the template particle.

Here, “a very small amount of metal to be replaced is deposited” means that the metal to be replaced is deposited to an extent to which the metal to be replaced is very thinly coated on the surface of the template particle 22, and “site-selectively” means that the catalyst metal is intentionally grown only on a specific region.

The method of depositing a very small amount of metal to be replaced on the surface of the template particle is not particularly restricted. For example, a solution obtained by mixing the template particle 22 and a surfactant may be prepared, and a precursor of metal to be replaced and a reducer may be added to the solution so as to react with the solution, whereby the metal to be replaced may be deposited.

The metal to be replaced may include any one selected from the group consisting of silver (Ag), copper (Cu), nickel (Ni), and a combination thereof. The precursor of the metal to be replaced may be a nitrate, sulfate, or halide of each of the above metal elements.

In the case in which an acid solution and a precursor of catalyst metal are added to the template particle having the metal to be replaced formed thereon so as to react with the template particle, the metal to be replaced may be replaced by catalyst metal, and the catalyst metal may be grown along the edges of the template particle 22, whereby a polyhedral framework 21 may be formed.

Specifically, the metal to be replaced may be replaced by the catalyst metal through galvanic replacement reaction. Here, “galvanic replacement reaction” means that, when a metal ion having a relatively high reduction potential and metal having a relatively low reduction potential contact each other in a solution, the metal ion and the metal react with each other stoichiometrically, whereby the metal ion having a relatively high reduction potential becomes metal and the metal having a relatively low reduction potential becomes a metal ion, and therefore the metal ion having a relatively high reduction potential is settled in the form of metal.

For example, galvanic replacement reaction occurs between metal to be replaced Ag⁰, deposited on the template particle, and a catalyst metal ion Pt⁴⁺, generated from a precursor of the catalyst metal. At this time, galvanic replacement reaction occurs on the edges of the template particle 22, which have higher surface energy than faces of the template particle 22, and Pt⁴⁺, is grown in the form of Pt⁰ along the edges of the template particle 22.

As a result, as shown in FIG. 6B, a material including the template particle 22 and the catalyst metal 21 grown along the edges of the template particle 22 may be obtained.

Subsequently, the obtained material may be etched using an etchant in a solution in order to remove the template particle 22. The etchant is not particularly restricted. An appropriate etchant may be selected and used depending on the kind of the template particle 22.

When the template particle 22 is removed, as shown in FIG. 6C, a catalyst 20, which is a hollow (H) nanoparticle having a polyhedral framework 21 defined by frames interconnected three-dimensionally, may be obtained.

The catalyst 20 is mixed with the ionomer in the presence of an alcohol-based solvent in order to obtain a mixture (S20).

The alcohol-based solvent is not particularly restricted. For example, the alcohol-based solvent may include methanol, ethanol, propanol, n-butanol, and isobutanol. In addition, the alcohol-based solvent may be mixed with an aqueous solvent in a predetermined ratio.

Mixing of the catalyst and the ionomer is not particularly restricted. For example, a stirrer may be used, or sonication may be performed. In the case in which the stirrer is used, the mixing may be performed at about 100 RPM for about 1 hour. In the case in which sonication is performed, ultrasonic waves may be radiated for about 1 minute to mix the catalyst and the ionomer with each other.

An electrolyte layer may be formed using the mixture. The method of forming the electrolyte layer is not particularly restricted. The mixture may be coated on a substrate in order to form the electrolyte layer.

The electrolyte layer including the reinforcement layer 30 may be manufactured as follows.

First, a porous reinforcement layer may be impregnated with an ionomer, and the mixture may be coated on at least one surface of the reinforcement layer in order to form an electrolyte layer.

Specifically, an ionomer is coated on a substrate, and the reinforcement layer is placed thereon such that the reinforcement layer is impregnated with the ionomer. The reinforcement layer impregnated with the ionomer is dried at 70° C. to 80° C. for 1 hour to 2 hours. Subsequently, the mixture is coated and dried on at least one of the dried reinforcement layer in order to form the electrolyte layer.

Hereinafter, the present disclosure will be described in more detail with reference to concrete examples. However, the following examples are merely an illustration to assist in understanding the present disclosure, and the present disclosure is not limited by the following examples.

### Manufacturing Example

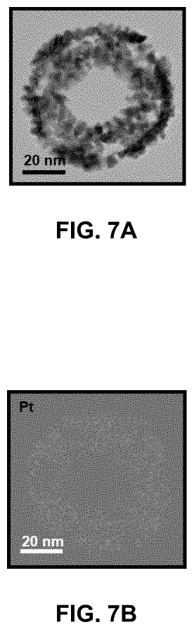

A polyhedral gold nanoparticle was used as the template particle. The template particle and cetrimonium bromide (CTAB), as a surfactant, were mixed with each other, and a very small amount of silver (Ag), as metal to be replaced, was deposited on the surface thereof. Silver nitrate (AgNO₃) was used as a precursor of metal to be replaced, and ascorbic acid was used as a reducer. Hexachloroplatinate(H₂PtCl₆), as a precursor of catalyst metal, was added to the resultant such that galvanic replacement reaction occurred between the metal to be replaced and the catalyst metal. Subsequently, the template particle was etched to obtain a catalyst. FIG. 7A is a view showing the result of analysis of the catalyst using a transmission electron microscope. Referring to this figure, it can be seen that the template particle was removed and thus a hollow nanoparticle having a polyhedral framework was formed. FIG. 7B is a view showing the result of analysis of the catalyst using an energy dispersive X-ray spectroscope (EDS). Referring to this figure, it can be seen that the framework was made of platinum, as the catalyst metal.

The catalyst was introduced into a mixed solvent of ethanol and water, and the same was mixed with perfluorosulfonic acid, as an ionomer, to manufacture a mixture. The mixture was stirred using a stirrer at about 100 RPM for about 1 hour.

Porous expanded polytetrafluoroethylene (e-PTFE) was used as a reinforcement layer, and was impregnated with perfluorosulfonic acid, as an ionomer. The mixture was coated and dried on one surface of the reinforcement layer to form an electrolyte membrane as shown in FIG. 4.

### Experimental Example

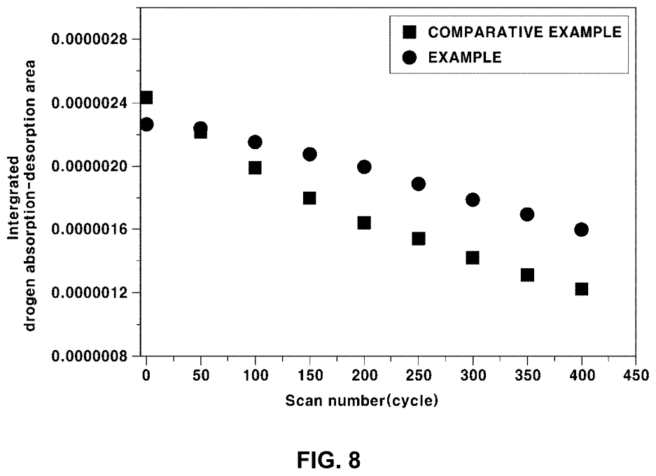

Example is a membrane-electrode assembly obtained by forming a positive electrode and a negative electrode on opposite surfaces of the electrolyte membrane according to Manufacturing Example, and Comparative Example is a membrane-electrode assembly formed using Pt/C instead of the catalyst according to Manufacturing Example. FIG. 8 is a view showing the result of measurement of reaction area of the catalyst including the hollow nanoparticle having the polyhedral framework in the ionomer of the electrolyte membrane of each of the membrane-electrode assemblies according to Example and Comparative Example. Specifically, the extent to which absorption-desorption area of the catalyst and hydrogen was decreased was compared while cyclic voltammetry (CV) was repeatedly performed. It can be seen from the evaluation of durability of the membrane-electrode assemblies through repetition of CV cycles that the extent to which the reaction area of the catalyst according to Example is decreased is smaller than the extent to which the reaction area of the catalyst according to Comparative Example is decreased.

That is, a decrease in the reaction area of the catalyst according to Example is smaller than a decrease in the reaction area of the catalyst according to Comparative Example, and therefore the durability of the membrane-electrode assembly according to Example is higher than durability of the membrane-electrode assembly according to Comparative Example.

As is apparent from the foregoing, the electrolyte membrane for membrane-electrode assemblies according to the present disclosure includes a catalyst, and therefore it is possible to more effectively remove hydrogen and oxygen crossing over in the electrolyte membrane, whereby chemical durability of the electrolyte membrane is greatly improved.

In addition, the electrolyte membrane for membrane-electrode assemblies according to the present disclosure uses a catalyst that has no carbon support and thus is self-supported as the catalyst, and therefore insulation of the electrolyte membrane is prevented from being broken by the carbon support, and the electrolyte membrane is prevented from being damaged due to degradation of the carbon support, whereby cycle characteristics of the electrolyte membrane are further improved.

The effects of the present disclosure are not limited to those mentioned above. It should be understood that the effects of the present disclosure include all effects that can be inferred from the foregoing description of the present disclosure.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. An electrolyte membrane for membrane-electrode assemblies, the electrolyte membrane comprising:
an electrolyte layer comprising a proton conductive ionomer; and
a catalyst dispersed in the electrolyte layer;
wherein the catalyst comprises a hollow nanoparticle having a polyhedral framework.

2. The electrolyte membrane according to claim 1, wherein the ionomer comprises a perfluorinated ionomer.

3. The electrolyte membrane according to claim 1, wherein the framework of the catalyst comprises catalyst metal selected from a group consisting of platinum (Pt), palladium (Pd), rhodium (Rh), iridium (Ir), ruthenium (Ru), and a combination thereof.

4. The electrolyte membrane according to claim 1, wherein the catalyst is self-supported.

5. The electrolyte membrane according to claim 1, wherein the catalyst has an average particle diameter of 40 nm to 70 nm.

6. The electrolyte membrane according to claim 1, wherein a content of the catalyst is 0.001 mg/cm³ to 0.2 mg/cm³.

7. The electrolyte membrane according to claim 1, further comprising:
a porous reinforcement layer impregnated with an ionomer, wherein the electrolyte layer is formed on at least one surface of the reinforcement layer.

8. The electrolyte membrane according to claim 7, wherein the reinforcement layer comprises any one selected from a group consisting of polytetrafluoroethylene (PTFE), expanded polytetrafluoroethylene (e-PTFE), polyethylene (PE), polypropylene (PP), polyphenylene oxide (PPO), polybenzimidazole (PBI), polyimide (PI), polyvinylidene fluoride (PVdF), polyvinyl chloride (PVC), and a combination thereof.

9. A method of manufacturing an electrolyte membrane for membrane-electrode assemblies, the method comprising:
preparing a catalyst including a hollow nanoparticle having a polyhedral framework;
manufacturing a mixture comprising the catalyst and a proton conductive ionomer; and
forming an electrolyte layer using the mixture.

10. The method according to claim 9, wherein the preparing a catalyst comprises:
preparing a polyhedral template particle;
growing catalyst metal along edges of the template particle to form a polyhedral framework; and
removing the template particle.

11. The method according to claim 10, wherein the forming a polyhedral framework comprises:
depositing a small amount of metal to be replaced on a surface of the template particle; and
replacing the metal to be replaced by catalyst metal and site-selectively growing the catalyst metal along the edges of the template particle.

12. The method according to claim 10, wherein the template particle comprises any one selected from a group consisting of gold (Au), copper (Cu), cobalt (Co), and a combination thereof.

13. The method according to claim 11, wherein the metal to be replaced comprises any one selected from a group consisting of silver (Ag), copper (Cu), nickel (Ni), and a combination thereof.

14. The method according to claim 10, wherein the catalyst metal comprises any one selected from a group consisting of platinum (Pt), palladium (Pd), rhodium (Rh), iridium (Ir), ruthenium (Ru), and a combination thereof.

15. The method according to claim 10, wherein the template particle is removed in a solution by etching using an etchant.

16. The method according to claim 9, wherein the catalyst has an average particle diameter of 40 nm to 70 nm.

17. The method according to claim 9, wherein the mixture is manufactured by mixing the catalyst with the ionomer in presence of an alcohol-based solvent.

18. The method according to claim 9, wherein a content of the catalyst is 0.001 mg/cm³ to 0.2 mg/cm³.

19. The method according to claim 9, wherein
a porous reinforcement layer is impregnated with an ionomer, and
the mixture is coated on at least one surface of the reinforcement layer impregnated with the ionomer to form an electrolyte layer.

20. The method according to claim 19, wherein the reinforcement layer comprises any one selected from a group consisting of polytetrafluoroethylene (PTFE), expanded polytetrafluoroethylene (e-PTFE), polyethylene (PE), polypropylene (PP), polyphenylene oxide (PPO), polybenzimidazole (PBI), polyimide (PI), polyvinylidene fluoride (PVdF), polyvinyl chloride (PVC), and a combination thereof.
